(19) United States
(12) Patent Application Publication
(10) Pub. No.: US 2024/0241233 A1
(43) Pub. Date: Jul. 18, 2024

(54) METHOD FOR OPERATING A DETECTION DEVICE, DETECTION DEVICE, AND VEHICLE COMPRISING AT LEAST ONE DETECTION DEVICE

(71) Applicant: VALEO SCHALTER UND SENSOREN GMBH, Bietigheim-Bissingen (DE)

(72) Inventors: Thorsten Beuth, Bietigheim-Bissingen (DE); Christoph Parl, Bietigheim-Bissingen (DE); Jonas Krause, Bietigheim-Bissingen (DE)

(73) Assignee: VALEO SCHALTER UND SENSOREN GMBH, Bietigheim-Bissingen (DE)

(21) Appl. No.: 18/562,329

(22) PCT Filed: May 10, 2022
(86) PCT No.: PCT/EP2022/062523

§ 371 Date: Nov. 19, 2023

(30) Foreign Application Priority Data
May 19, 2021 (DE) 10 2021 112 942.7

(51) Int. Cl. G01S 7/4915; G01S 7/481; G01S 17/931

(52) U.S. Cl. CPC G01S 7/4915; G01S 7/4814; G01S 17/931

(57) ABSTRACT

A method for operating a detection device for determining distance variables that characterize distances of detected objects is described. A modulated electrical transmission signal is used to produce a correspondingly modulated electromagnetic scanning signal, which is transmitted into a monitoring region. At least one reception range (EL) is used to detect at least one signal portion of an electromagnetic echo signal of the scanning signal in at least one defined capture time range (TB) and to convert it into a corresponding electrical received signal. At least one received signal is used to determine at least one distance variable. At least one defined capture time range (TB) that is shorter than a modulation period of the at least one transmission signal is predefined. For at least one modulation period sequence (MPS), which comprises at least one modulation period of the at least one transmission signal, at least two reception ranges (EL) are used to detect respective signal portions of the echo signal as electrical reception variables in different defined capture time ranges (TB). In at least two successive modulation period sequences (MPS), at least two reception ranges (EL) are used to detect respective signal portions of the echo signal as electrical reception variables in different capture time ranges (TB). The interval of time between the at least two capture time ranges (TB) is shorter than the period duration of a modulation period of the electrical transmission signal.

### TECHNICAL FIELD

The invention relates to a method for operating a detection device for determining at least distance variables that characterize distances of objects detected using the detection device, wherein at least one modulated electrical transmission signal is used to generate at least one accordingly modulated electromagnetic scanning signal, which is transmitted into at least one monitoring area of the detection device, at least one receiving area detects at least one signal portion of at least one electromagnetic echo signal of at least one scanning signal reflected by at least one object in at least one defined acquisition time range and converts said signal portion into a corresponding electrical received signal, at least one defined acquisition time range being specified that is shorter than a modulation period of the at least one electrical transmission signal, and at least one electrical received signal is used to determine at least one distance variable.

Furthermore, the invention relates to a detection device for determining at least distance variables that characterize distances of objects detected using the detection device, having at least one transmitting apparatus that allows at least one modulated electrical transmission signal to be used to generate at least one electromagnetic scanning signal that can be transmitted into at least one monitoring area of the detection device, having at least one receiving apparatus having at least one receiving area that can be used to detect at least one signal portion of at least one electromagnetic echo signal of at least one scanning signal reflected by at least one object in at least one defined acquisition time range and to convert said signal portion into a corresponding electrical received signal, having at least one means that can be used to specify at least one defined acquisition time range that is shorter than a modulation period of the at least one electrical transmission signal,
and having at least one means that allows at least one electrical received signal to be used to determine at least one distance variable.

Furthermore, the invention relates to a vehicle having at least one detection device for determining at least distance variables that characterize distances of objects detected using the detection device, having at least one transmitting apparatus that allows at least one modulated electrical transmission signal to be used to generate at least one electromagnetic scanning signal that can be transmitted into at least one monitoring area of the detection device, having at least one receiving apparatus having at least one receiving area that can be used to detect at least one signal portion of at least one electromagnetic echo signal of at least one scanning signal reflected by at least one object in at least one defined acquisition time range and to convert said signal portion into a corresponding electrical received signal, having at least one means that can be used to specify at least one defined acquisition time range that is shorter than a modulation period of the at least one electrical transmission signal, and having at least one means that allows at least one electrical received signal to be used to determine at least one distance variable.

### PRIOR ART

EP 2 743 724 B1 discloses a TOF (Time-of-Flight) distance sensor and a method for operating a TOF distance sensor. The TOF distance sensor comprises an electronic apparatus for generating a modulation signal and for generating four correlation signals that are phase-shifted relative to one another and have the same period length as the modulation signal; a radiation source for emitting radiation modulated with the modulation signal; a receiving apparatus that is in a predetermined spatial relation to the radiation source for receiving radiation reflected from the object; a correlation apparatus for correlating the received radiation or a corresponding variable with one specific instance of the four correlation signals to form four corresponding correlation values; a difference-forming apparatus for forming two difference correlation values from the difference between two specific instances of the correlation values; a computation apparatus designed to compute the distance in predetermined linear dependence on the two difference correlation values.

The invention is based on the object of designing a method, a detection device and a vehicle of the type mentioned in the introduction that allow the determination of distances to be improved. In particular, the aim is to improve a resolution when determining distance and/or to reduce blurred motion (motion blur) when determining the distance.

### DISCLOSURE OF THE INVENTION

The invention achieves this object for the method in that for at least one modulation period sequence, which comprises at least one modulation period of the at least one electrical transmission signal, for at least one modulation period of the at least one electrical transmission signal, at least two receiving areas are used to detect respective signal portions of the at least one echo signal as electrical receive variables in different defined acquisition time ranges, and in at least two consecutive modulation period sequences, for at least one specific modulation period of at least one electrical transmission signal, at least two receiving areas are used to detect respective signal portions of the at least one echo signal as electrical receive variables in different acquisition time ranges, the interval of time between the at least two acquisition time ranges being shorter than the period duration of a modulation period of the at least one electrical transmission signal.

According to the invention, at least one received echo signal is detected using at least two receiving areas in at least two different acquisition time ranges. The receive variables detected using the respective receiving areas define respective support points that can be used to approximate a characteristic of a reception envelope that corresponds to a modulation of the at least one transmission signal at the receiver end. The corresponding signal portion of the received echo signal is detected in each of the at least two acquisition time ranges.

The interval of time between the at least two acquisition time ranges is shorter than the period duration of the modulation period of the at least one transmission signal. The signal portions detected in each of the respective acquisition time ranges can thus be used to characterize the time characteristic of the reception envelope within the period duration of a modulation period. A phase shift of the reception envelope relative to the transmission signal can be determined from the detected signal portions. The phase shift characterizes the signal propagation time between the transmission of the scanning signal and the reception of the echo signal. The distance of a reflecting object can be determined from the signal propagation time. The phase shift can thus be used as at least one distance variable.

A modulation period sequence comprises at least one modulation period of the at least one electrical transmission signal. Advantageously, at least one modulation period sequence can comprise a plurality of, in particular approximately 1000 or more, modulation periods. Advantageously, the electrical receive variables in the same modulation period sequence can be determined in the same manner, in particular with the same actuation of the receiving areas.

Advantageously, at least one transmission signal and thus at least one scanning signal can be amplitude-modulated over at least one modulation period. This allows reception envelopes to be efficiently characterized at the receiver end using the receive variables determined by the receiving areas in the respective acquisition time ranges. The transmission signals and the reception envelope can be directly compared with each other.

At least one scanning signal is generated from at least one transmission signal. The transmission signals are modulated, in particular amplitude-modulated. The transmission signals have a modulation period within which the at least one electrical transmission signal is modulated. A modulation period can be specified as an interval of time or on the basis of a circular function, in particular as 360° or 2π. Accordingly, the reception envelope is the envelope of the received signals that can be formed from the received echo signal.

Advantageously, at least one modulation period of at least one transmission signal can have a period duration in the order of magnitude of approximately 10 ms to 100 ms, in particular between 40 ms and 50 ms. Such period durations allow distances of objects at several tens of meters, in particular a few hundred meters, to be recorded.

Advantageously, the at least one detection apparatus can operate according to an indirect signal propagation time method. Optical detection apparatuses operating according to a signal propagation time method can be designed and referred to as time-of-flight (TOF) systems, light detection and ranging systems (LiDAR), laser detection and ranging systems (LaDAR), radar systems or the like. An indirect signal propagation time method can involve determining a phase shift of the received signal relative to the transmission signal due to the propagation time of the scanning signal and the corresponding echo signal. The distance of an object by which the applicable scanning signal is reflected can be determined from the phase shift.

Advantageously, the electromagnetic scanning signals used can be optical scanning signals, in particular light signals, especially laser signals. Electromagnetic scanning signals, in particular light signals, can be used to detect objects contactlessly. Accordingly, the detection device can be an optical detection device.

Advantageously, the detection device can be designed as a laser-based distance measurement system. A laser-based distance measurement system can comprise at least one laser, in particular a diode laser, as the light source of a transmitting apparatus. The at least one laser can be used to transmit in particular pulsed light scanning signals. The laser can be used to emit scanning signals in wavelength ranges that are visible or not visible to the human eye. Accordingly, at least one receiver can comprise at least one detector designed for the wavelength of the transmitted light, in particular a point sensor, line sensor or area sensor, especially an (avalanche) photodiode, a photodiode linear array, a CCD sensor, an active pixel sensor, in particular a CMOS sensor, or the like. The laser-based distance measurement system can advantageously be a laser scanner. A laser scanner can be used to scan a monitoring area with an in particular pulsed scanning signal.

The invention can advantageously be used in vehicles, in particular motor vehicles. The invention can advantageously be used in land vehicles, in particular passenger vehicles, trucks, buses, motorcycles or the like, aircraft, in particular drones, and/or watercraft. The invention can also be used in vehicles that can be operated autonomously or at least semiautonomously. However, the invention is not restricted to vehicles. It can also be used in stationary operation, in robotics and/or in machines, in particular construction or transport machinery, such as cranes, excavators or the like.

The detection device can advantageously be connected to or can be part of at least one electronic control device of a vehicle or of a machine, in particular a driver assistance system and/or a chassis control system and/or a driver information device and/or a parking assistance system and/or a gesture recognition system or the like. This allows at least some of the functions of the vehicle or of the machine to be operated autonomously or semiautonomously.

The detection device can be used for detecting stationary or moving objects, in particular vehicles, persons, animals, plants, obstacles, roadway irregularities, in particular potholes or rocks, roadway boundaries, traffic signs, open spaces, in particular parking spaces, precipitation or the like, and/or movements and/or gestures.

In one advantageous embodiment of the method, at least one acquisition time range can be specified according to at least one defined event with regard to the at least one electrical transmission signal, and/or at least one acquisition time range can be started based on a start event for the at least one electrical transmission signal and/or for at least one modulation period of at least one electrical transmission signal.

This allows a direct temporal correlation to be formed between the at least one electrical transmission signal and the at least one electrical received signal. The phase shift and the distance can be determined from the temporal correlation.

Advantageously, a start event for the at least one scanning signal can be produced by means of at least one trigger signal. This allows the control to be carried out electronically.

In another advantageous embodiment of the method, at least one acquisition time range can be specified by actuating at least one receiving area with at least one acquisition control signal, and/or at least one acquisition time range can be specified by actuating at least one receiving area with at least one periodic acquisition control signal.

At least one acquisition control signal can be used to specify defined acquisition time ranges in which the at least two receiving areas can detect the respective signal portions of the at least one echo signal.

Advantageously, the at least one acquisition control signal, in particular at least one shutter signal, can be used to actuate applicable shutters of the or for the receiving areas.

Advantageously, at least one acquisition control signal can be configured such that it can be used to specify a start time and/or an end time and/or a duration of at least one acquisition time range. This allows the at least one acquisition time range to be defined more precisely.

Advantageously, at least one acquisition control signal can have or consist of at least one signal pulse of defined length. This allows the at least one acquisition control signal to be used to specify a start time for at least one acquisition time range and/or a duration of the at least one acquisition time range.

A periodic correlation signal can be used to define multiple acquisition time ranges one after the other.

In another advantageous embodiment of the method, at least one receiving area can be used for consecutive modulation period sequences, for at least one specific modulation period of at least one electrical transmission signal, to detect at least one specific signal portion of at least one echo signal in a respective defined acquisition time range, the same defined acquisition time ranges being used for at least one specific modulation period of the at least one transmission signal for at least two consecutive modulation period sequences, and/or at least one receiving area can be used in consecutive modulation period sequences, for at least one specific modulation period of at least one transmission signal, to detect at least one specific signal portion of at least one echo signal in a respective defined acquisition time range, different defined acquisition time ranges being used for at least one specific modulation period of the at least one transmission signal for at least two consecutive modulation period sequences.

At least one receiving area can be used to detect the applicable signal portions of the echo signal in the same defined acquisition time range for at least one specific modulation period in at least two consecutive modulation period sequences. This allows this at least one receiving area to be assigned the same support point for the reception envelope over multiple modulation period sequences.

Identical acquisition time ranges can have the same duration and the same temporal position within the subsequent modulation period sequences of the at least one transmission signal. This allows the acquisition time ranges to be directly compared with each other.

Alternatively or additionally, at least one receiving area can be used to detect the applicable signal portions of the at least one echo signal in different defined acquisition time ranges for a specific modulation period in at least two consecutive modulation period sequences. This allows at least one receiving area to be used to detect altogether two different support points for at least one reception envelope in two consecutive modulation period sequences. Thus, an approximation of the characteristic of the reception envelope can already be produced with two consecutive modulation period sequences and one receiving area.

In another advantageous embodiment of the method, in at least two consecutive modulation period sequences, for at least one specific modulation period of at least one electrical transmission signal, at least two receiving areas can be used to detect respective signal portions of the at least one echo signal as electrical receive variables in the same acquisition time range.

In at least two consecutive modulation period sequences, at least two receiving areas can be used to detect signal portions of the at least one echo signal in the same acquisition time range. This allows a support point for at least one reception envelope to be produced using different receiving areas in at least two modulation period sequences. In addition, different acquisition time ranges can thus be used in a modulation period sequence with the at least two receiving areas.

Alternatively or additionally, at least two receiving areas can be used to detect respective signal portions of the at least one echo signal as electrical receive variables in different acquisition time ranges in at least two consecutive modulation period sequences. Two support points for at least one reception envelope can thus be produced using different receiving areas in successive modulation period sequences.

In another advantageous embodiment of the method, at least two adjacent receiving areas can be used in the same modulation period sequence, for at least one specific modulation period of at least one transmission signal, to detect the respective signal portions in acquisition time ranges that are adjacent with respect to the group of acquisition time ranges that are used, and/or, in at least two consecutive modulation period sequences, for at least one specific modulation period of at least one transmission signal, to detect respective signal portions in acquisition time ranges that are adjacent with respect to a group of acquisition time ranges that are used.

At least two adjacent receiving areas can be used to detect the respective signal portions in adjacent acquisition time ranges in the same modulation period sequence of at least one transmission signal. This allows multiple support points for the at least one reception envelope to be determined promptly using at least two receiving areas. This can reduce the motion blur.

Alternatively or additionally, respective signal portions can be detected in adjacent acquisition time ranges in two consecutive modulation period sequences of at least one transmission signal. This allows the support points for the at least one reception envelope to be distributed over multiple directly subsequent modulation period sequences. This allows the number of receiving areas involved for promptly detecting different support points to be reduced.

A group of defined different acquisition time ranges can be used for the method. The acquisition time ranges can be defined here in such a way that they can be used to define support points that can be used to at least approximate a characteristic of the reception envelope.

Advantageously, a group can comprise at least two acquisition time ranges, in particular four acquisition time ranges. The acquisition time ranges can advantageously be evenly distributed over the modulation periods. This allows the approximation of a reception envelope to be improved.

In another advantageous embodiment of the method, in at least one modulation period sequence, for at least one specific modulation period of at least one transmission signal, multiple receiving areas can be used to detect respective signal portions of at least one echo signal altogether in all acquisition time ranges of a group of acquisition time ranges that are used for the method, and/or in two consecutive modulation period sequences, for at least one specific modulation period of at least one transmission signal, multiple receiving areas can be used to detect respective signal portions of at least one echo signal altogether in all acquisition time ranges of a group of acquisition time ranges that are used for the method. This allows all support points in the group to be promptly used to approximate the characteristic of the reception envelope. This allows the resolution for determining the distance to be improved.

In another advantageous embodiment of the method, signal sections of at least one echo signal that are detected using multiple receiving areas for at least one specific modulation period of at least one transmission signal in the same modulation period sequence can be used to determine at least one distance variable, and/or signal sections of at least one echo signal that can be detected using at least one receiving area for at least one specific modulation period of at least one transmission signal in at least two successive modulation period sequences can be used to determine at least one distance variable. When using multiple receiving areas in the same modulation period of at least one transmission signal, the respective support points for characterizing the characteristic of the reception envelope can be detected promptly within a modulation period. This allows the resolution for determining the distance variable to be improved further.

When using subsequent modulation period sequences to determine at least one distance variable, the number of receiving areas required can be reduced. Thus, even a smaller number of receiving areas can be used to determine at least one distance variable.

In another advantageous embodiment of the method, at least one acquisition time range can be referenced to at least one characteristic point in at least one electrical transmission signal and/or at least one scanning signal. This allows the at least one acquisition time range to be assigned more easily and/or uniquely.

Advantageously, at least one characteristic point in at least one transmission signal and/or at least one scanning signal to which at least one acquisition time range can be referenced can be a maximum, a minimum, a point of inflection, a zero crossing, an edge of the at least one transmission signal and/or the at least one scanning signal. This allows the characteristic point to be determined more precisely.

In another advantageous embodiment of the method, intervals of time between at least two acquisition time ranges of a group of acquisition time ranges that are used can be specified according to the intervals of time between characteristic points in at least one electrical transmission signal and/or at least one scanning signal. This allows the correlations between the acquisition time ranges to be produced more easily and/or more uniquely.

Advantageously, at least one modulation period of at least one electrical transmission signal can be an integer multiple of at least one interval between two acquisition time ranges of a group of acquisition time ranges that are used. This allows the acquisition time ranges used to be evenly distributed within the at least one modulation period of the at least one transmission signal.

Advantageously, at least one modulation period of at least one electrical transmission signal can be specified as 360° or 2π. At least one interval between at least two acquisition time ranges can be an integer multiple of 90° or π/2.

In another advantageous embodiment of the method, at least one electrical transmission signal can be produced as a square-wave signal, a sinusoidal signal, a triangular-waveform signal or a sawtooth signal or the like. Such signal forms can be produced relatively easily. In addition, such signal forms can already be approximated using two, in particular four, support points.

In another advantageous embodiment of the method, at least two receiving areas, which can be spatially adjacent, can be used to detect at least one specific signal portion of at least one echo signal in respective defined acquisition time ranges, the interval of time between which is shorter than the period duration of a modulation period of at least one transmission signal, and/or at least one echo signal can be directed to the receiving areas in such a way that at least two receiving areas that can be used to detect a specific signal portion of the at least one echo signal in respective defined acquisition time ranges are hit by the at least one echo signal at the same time, and/or at least one receiving area can be formed from at least two receiving elements that can be arranged in such a way that they can be hit by respective components of the at least one echo signal that are transmitted to the at least one receiving area according to a direction of a reflecting object relative to the detection device, the at least two receiving elements being able to be used to detect the respective components of the at least one echo signal separately.

Advantageously, at least two receiving areas that can each be used to detect a signal portion of at least one echo signal can be spatially adjacent. This allows an expansion of the at least one received signal that is necessary to cover all the relevant receiving areas to be reduced.

Alternatively or additionally, at least one echo signal can advantageously be directed to the receiving areas in such a way that at least two receiving areas that can each be used to detect a signal portion of the at least one echo signal in respective defined acquisition time ranges are hit by the at least one echo signal at the same time. This allows the information obtained by the receiving areas to be directly related to each other.

Alternatively or additionally, at least one receiving area can advantageously be formed from at least two receiving elements. The at least two may be arranged in such a way that they can be hit by respective components of the at least one echo signal. The components can hit the respective receiving elements according to the direction from which the at least one echo signal is reflected. This allows directional resolution to be achieved with the at least one receiving area. Thus, the detection device can additionally be used to determine at least one directional component for the direction in which the reflecting object is located relative to the detection device. Depending on the direction from which the at least one echo signal comes, one or more receiving elements may also not be hit by the echo signal, meaning that the component of the echo signal that hits said receiving elements is equal to zero.

Advantageously, the receiving elements of at least one receiving area can detect the respective signal portion of the at least one echo signal in the same defined acquisition time range. Thus, each receiving element can additionally be used to obtain information for determining the at least one distance variable.

Advantageously, more than two receiving elements of at least one receiving area may be arranged linearly. This allows the direction to be determined in a spatial dimension, in particular spatially vertically or spatially horizontally.

The invention also achieves the object for the detection device in that the detection device comprises at least two receiving areas that can be used to detect respective signal portions of the at least one echo signal as electrical receive variables in different defined acquisition time ranges, and the detection device comprises means for producing at least two acquisition time ranges, the interval of time between which is shorter than the period duration of a modulation period of the at least one transmission signal.

According to the invention, the detection device comprises means that can be used to specify acquisition time ranges for receiving areas in a defined manner. This allows the receiving areas to be used to detect respective signal portions of the echo signals. The interval of time between the acquisition time ranges is shorter than the period duration of a modulation period of the at least one transmission signal. This allows multiple support points for a reception envelope to be produced within a modulation period that forms a range of uniqueness for the distance determination.

Advantageously, the means can comprise at least one signal generating means that is used to generate at least one acquisition control signal. The at least one task control signal can be used to specify the receiving areas by means of appropriate signals, in particular signal pulses or the like.

Advantageously, at least one receiving area can have at least one associated controllable shutter. A shutter can be used to control incidence of an echo signal on the applicable receiving area. Alternatively or additionally, at least one receiving area can be activated or deactivated for detecting echo signals by way of a read routine.

In one advantageous embodiment, at least one receiving area can comprise multiple receiving elements. This can facilitate spatial resolution. It is thus possible to determine at least one directional component for a direction from which at least one echo signal comes and in which a reflecting object is located relative to the detection device.

Advantageously, the acquisition elements of at least one receiving area can be controllable using at least one means for detecting signal portions in the same defined acquisition time range. This allows all the acquisition elements of at least one receiving area to be used to detect the incident components of the at least one echo signal and allows said components to be used to determine both the distance variables and the direction variables that can characterize the direction of a detected object.

In addition, the invention achieves the object for the vehicle in that the detection device comprises at least two receiving areas that can be used to detect respective signal portions of the at least one echo signal in different defined acquisition time ranges, and the detection device comprises means for producing at least two acquisition time ranges, the interval of time between which is shorter than the period duration of a modulation period of the at least one transmission signal. This allows distances of objects relative to the vehicle to be determined.

Advantageously, the means for specifying defined acquisition time ranges and the means for determining at least one distance variable can be realized by way of software and/or hardware. Advantageously, some or all of the above means can be realized by means of at least one control and evaluation apparatus, at least one transmitting apparatus and/or at least one receiving apparatus.

The vehicle can advantageously comprise at least one driving assistance system. The vehicle can be operated autonomously or at least semiautonomously using the driver assistance system.

Advantageously, at least one detection device can be connected to at least one driver assistance system of the vehicle for signal transfer purposes. This allows information about the monitoring area, in particular distance variables and/or direction variables that can be determined using the at least one detection device, to be transmitted to the at least one driver assistance system. The vehicle can be operated autonomously or at least semiautonomously using the at least one driver assistance system in consideration of the information about the monitoring area.

Moreover, the features and advantages indicated in connection with the method according to the invention, the detection device according to the invention and the vehicle according to the invention and the respective advantageous configurations thereof apply in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in greater detail with reference to the drawing. A person skilled in the art will expediently also consider individually the features that have been disclosed in combination in the drawing, the description and the claims and will combine them to form meaningful further combinations. In the schematic figures,

FIG. 1 shows the front view of a vehicle having a driver assistance system and a LiDAR system for determining distances from objects in relation to the vehicle;

FIG. 2 shows a functional representation of the vehicle with the driver assistance system and the LiDAR system from FIG. 1;

FIG. 3 shows a front view of a receiver of a receiving apparatus of the LiDAR system from FIGS. 1 and 2;

FIG. 4 shows a signal strength-time graph with receive variables, which is determined from an electromagnetic echo signal of a reflected electromagnetic scanning signal of the LiDAR system from FIGS. 1 and 2;

FIG. 5 shows a signal strength-time graph of an electromagnetic scanning signal of the LiDAR system from FIGS. 1 and 2;

FIG. 6 shows signal strength-time graphs of an electromagnetic echo signal, top, which can be received using the receiving apparatus of the LiDAR system from FIGS. 1 and 2, and of a first and a second shutter signal, middle and bottom, for determining a receive variable from the electromagnetic echo signals;

FIG. 7 shows a temporal control scheme for receiving areas of the receiver from FIG. 3 according to a first exemplary embodiment;

FIGS. 8 to 11 show respective signal strength-time graphs with receive variables, which are determined according to the control scheme from FIG. 7 in, for example, four measuring periods;

FIG. 12 shows a temporal control scheme for receiving areas of the receiver from FIG. 3 according to a second exemplary embodiment;

FIG. 13 shows a temporal control scheme for receiving areas of the receiver from FIG. 3 according to a third exemplary embodiment;

FIG. 14 shows a temporal control scheme for receiving areas of the receiver from FIG. 3 according to a fourth exemplary embodiment.

In the figures, identical components are provided with identical reference signs.

### EMBODIMENT(S) OF THE INVENTION

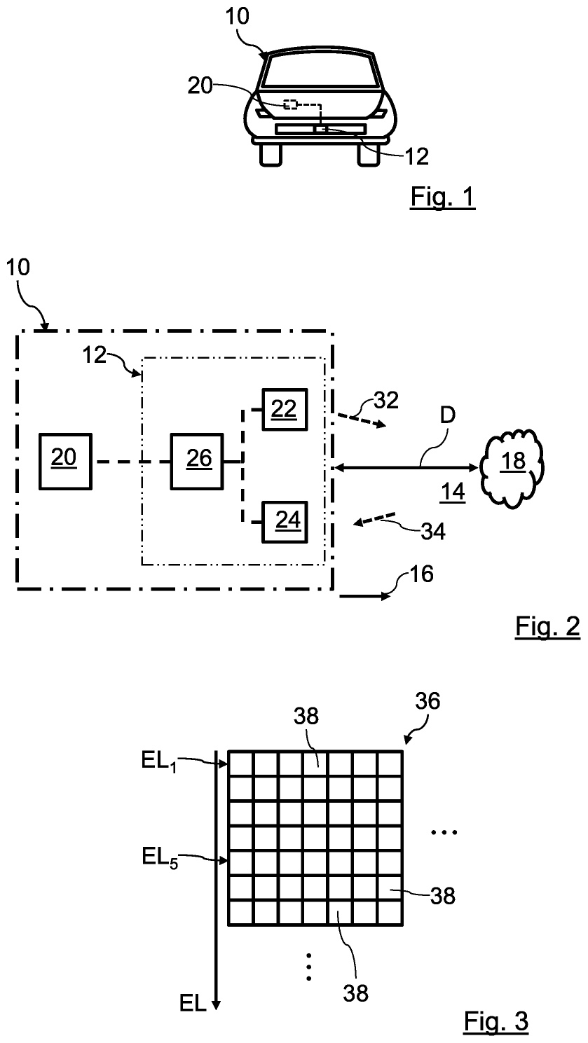

FIG. 1 shows the front view of a vehicle 10, for example in the form of a passenger vehicle. FIG. 2 shows a functional representation of a part of the vehicle 10.

The vehicle 10 has a detection device, for example in the form of a LiDAR system 12. The LiDAR system 12 is arranged in the front bumper of the vehicle 10, for example. The LiDAR system 12 can be used to monitor a monitoring area 14 in front of the vehicle 10 in the direction of travel 16 for objects 18. The LiDAR system 12 can also be arranged at another point on the vehicle 10 and oriented differently. The LiDAR system 12 can be used to determine object information, for example distances D, directions and speeds of objects 18 relative to the vehicle 10, or to the LiDAR system 12.

The objects 18 may be stationary or moving objects, for example other vehicles, persons, animals, plants, obstacles, roadway irregularities, for example potholes or rocks, roadway boundaries, traffic signs, open spaces, for example parking spaces, precipitation or the like.

The LiDAR system 12 is connected to a driver assistance system 20. The driver assistance system 20 can be used to operate the vehicle 10 autonomously or semiautonomously.

The LiDAR system 12 comprises, by way of example, a transmitting apparatus 22, a receiving apparatus 24 and a control and evaluation apparatus 26.

The functions of the control and evaluation apparatus 26 can be performed in a centralized or decentralized manner. Some of the functions of the control and evaluation apparatus 26 can also be integrated in the transmitting apparatus 22 or the receiving apparatus 24.

The control and evaluation apparatus 26 can be used to generate electrical transmission signals 28, such as a square-wave signal, which is indicated in dashed lines in FIG. 5. The transmitting apparatus 22 can be actuated with the electrical transmission signals 28, with the result that it transmits applicable electromagnetic scanning signals 32 in the form of light signals, as also shown for example in FIG. 5 in the form of square-wave signals, into the monitoring area 14. In FIG. 5, only one modulation period MP of the applicable scanning signal 32 is shown in a signal strength-time graph for the sake of better clarity. Merely for comparison, FIG. 5 shows the time characteristic of the applicable electrical transmission signal 28, the unit of the strength of the electrical transmission signal 28 differing from the signal strength Pₛ of the electromagnetic scanning signal 32.

The transmitting apparatus 22 can comprise one or more lasers, for example, as a light source. In addition, the transmitting apparatus 22 may optionally have a scanning signal deflection device that can be used to direct the scanning signal 32 into the monitoring area 14 as appropriate.

The electromagnetic scanning signals 32 reflected as electromagnetic echo signals 34 in the direction of the receiving apparatus 24 by an object 18 can be received by the receiving apparatus 24. As an example, the top of FIG. 6 shows an echo signal 34 that belongs to the scanning signal 32 from FIG. 5. Like the corresponding scanning signal 32, the echo signal 34 is also a square-wave signal.

The receiving apparatus 24 may optionally have an echo signal deflection device that is used to direct the electromagnetic echo signals 34 to a receiver 36 of the receiving apparatus 24, shown in the front view in FIG. 3. The receiver 36 is, for example, an area sensor in the form of a CCD sensor having a multiplicity of receiver pixels 38.

The receiver pixels 38 of the receiver 36 can be used to convert the respectively incident components of the electromagnetic echo signal 34 into corresponding electrical received signals.

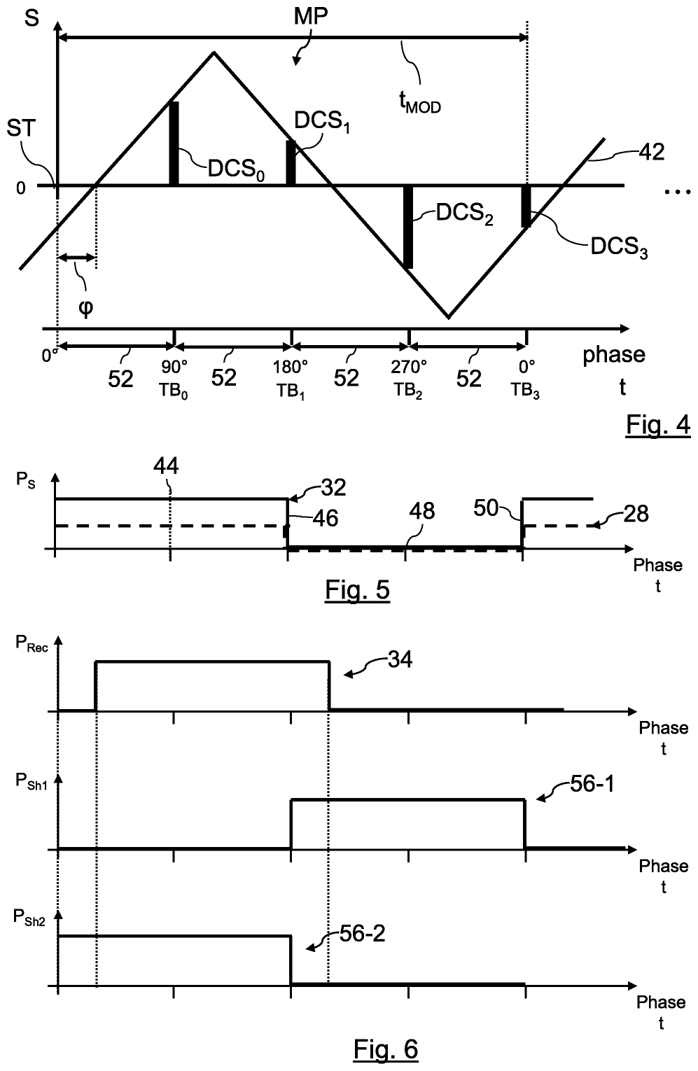

Each receiver pixel 38 can be activated for detecting electromagnetic echo signals 34 for defined acquisition time ranges TB by way of suitable shutter means. To allow better distinction, different acquisition time ranges TB may be provided with an index, for example i, that is to say can be referred to as the acquisition time range TBᵢ. As an example, the receiver pixels 38 can each be activated for detecting received signals 34 in a group of four acquisition time ranges TBᵢ, namely TB₀, TB₁, TB₂ and TB₃, which are indicated in FIG. 4, for example. Each acquisition time range TBᵢ is defined by a start time and a duration and/or an end time. Each of the acquisition time ranges TBᵢ is significantly shorter than the period duration t_{MOD} of the modulation period MP of the transmission signal and the electromagnetic scanning signal 32. The intervals of time between two specific defined acquisition time ranges TBᵢ of the group are shorter than the period duration t_{MOD} of the modulation period MP. Multiple consecutive modulation periods MP may be provided with a respective index, for example k, below to allow better distinction, that is to say can be referred to as the modulation period MPₖ.

During an acquisition time range TBᵢ, components of echo signals 34 hitting the respective receiver pixel 38 can be converted into corresponding electrical received signals. The signal strengths P_{Rec} of the received signals 40 can be used to determine respective receive variables DCS (Differential Correlation Sample) that characterize respective signal portions of the echo signal 34 in the respective acquisition time ranges TBᵢ. The receive variables DCS₀, DCS₁, DCS₂ and DCS₃ correspond to the respective amount of light collected during the acquisition time ranges TB₀, TB₁, TB₂ and TBs with the accordingly activated receiver pixels 38 of the receiver 36.

As an example, each receiver pixel 38 can be individually activated and read. The shutter means may be realized by software and/or hardware means. Such shutter means may be realized as so-called “shutters”. As an example, the receiver pixels 38 can be actuated with applicable periodic acquisition control signals in the form of shutter signals 56-1 and 56-2. As an example, the middle and bottom of FIG. 6 show the shutter signals 56-1 and 56-2 used to actuate the respective receiver pixels 38 to determine the receive variable DCS₀. The shutter signals 56-1 and 56-2 are both square-wave signals having the same period duration as the transmission signals 28, the scanning signals 32 and the echo signals 34. The shutter signals 56-1 and 56-2 are triggered by way of the electrical transmission signals or together with them. This relates the electrical received signals to the electrical transmission signals. As an example, the electrical transmission signals can be triggered at a start time ST, which is indicated in FIG. 4. The receiver pixels 34 are triggered with the accordingly time-shifted shutter signals 56-1 and 56-2.

The receiver pixels 38 are arranged in two dimensions in, by way of example, more than 100 receiver areas in the form of receiver lines ELᵢ each having, by way of example, more than 100 receiver pixels 38. As an example, the receiver pixels 38 of a receiver area ELU are activated at the same time in the same acquisition time range TBᵢ in a modulation period MPₖ. The receiver pixels 38 of adjacent receiver areas ELᵢ are activated, by way of example, in different acquisition time ranges TBᵢ in a modulation period MPₖ.

The receiving apparatus 24 optionally has optical elements that influence the electromagnetic echo signals 34, for example refractive elements, diffractive elements and/or reflecting elements or the like, which optical elements are used to map electromagnetic echo signals 34 coming from the monitoring area 14, when viewed in the direction of the receiver areas ELᵢ, to respective receiver pixels 38 according to the direction from which they come. Thus, the position of the illuminated receiver pixels 38 within the receiver areas ELᵢ can be used to determine the direction of an object 18 by which the scanning signal 38 is reflected. When viewed in the direction perpendicular to the receiver areas ELᵢ, the echo signals 34 are mapped as evenly as possible to the receiver pixels 38 in the same column of all the receiver areas ELᵢ.

FIG. 4 shows a modulation period MP of a reception envelope 42 of the receive variables DCS₀, DCS₁, DCS₂ and DCS₃ in a signal strength-time graph.

The reception envelope 42 is offset in time compared with the start time ST. The time offset in the form of a phase difference p characterizes the time of flight between the transmission of the electromagnetic scanning signal 32 and the reception of the corresponding electromagnetic echo signal 34.

The distance D can be determined from the phase difference p. The phase shift φ can therefore be used as a distance variable for the distance D. As is known, the time of flight is proportional to the distance D of the object 18 relative to the LiDAR system 12.

The period duration of the transmission signals 28 and the scanning signals 32 is referred to in FIG. 4 as t_{MOD}. The period duration t_{MOD} also specifies the maximum distance that can still be clearly recorded using the LiDAR system 12. The period duration t_{MOD} is greater than the time of flight of the scanning signal 32 and the echo signal 34 for reflections by objects 18 at the maximum distance of interest. The measurement duration of a measurement corresponds to the period duration t_{MOD}. As an example, the period duration t_{MOD} can be between 40 ms and 50 ms, for instance. Distance measurements can be performed continuously within the range of uniqueness. Distances outside the maximum distance, which are not within the range of uniqueness, can also be recorded by way of appropriate data processing, which is of no further interest here.

The reception envelope 42 can be approximated by for example four support points in the form of the four receive variables DCS, namely DCS₀, DCS₁, DCS₂ and DCS₃, which can be recorded in the applicable acquisition time ranges TB₀, TB₁, TB₂ and TB₃.

The acquisition time ranges TB₀, TB₁, TB₂ and TBs are each started with reference to a start event, for example in the form of a trigger signal for the electrical transmission signal 28. As an example, the modulation period MPₖ of the transmission signal 28 and thus of the scanning signal 32 extends over 360°. The acquisition ranges TB₀, TB₁, TB₂ and TBs each start at the time of a characteristic point in the transmission signal 28 and the scanning signal 32. By way of example, the acquisition range TB₀ starts in the middle of the timing of the maximum 44 of the transmission signal 28 and the scanning signal 32 in the 90° phase of the modulation period MPₖ. The acquisition range TB₁ starts at the time of the down edge 46 of the transmission signal 28 and the scanning signal 32 in the 180° phase of the modulation period MPₖ. The acquisition range TB₂ starts in the middle of the timing of the minimum 48 of the transmission signal 28 and the scanning signal 32 in the 270° phase of the modulation period MP_{K}. The acquisition range TBs starts at the time of the up edge 50 of the transmission signal 28 and the scanning signal 32 in the 360° phase of the modulation period MP_{K}, or in the 0° phase at the beginning of the subsequent modulation period MPₖ₊₁. The intervals of time 52 between the start times of specific adjacent acquisition ranges are by way of example identical and correspond to the intervals of time between the characteristic points 44, 46, 48 and 50 in the transmission signal 28 and the scanning signal 32, that is to say at intervals of time of 90° with reference to the period duration t_{MOD} of 360°.

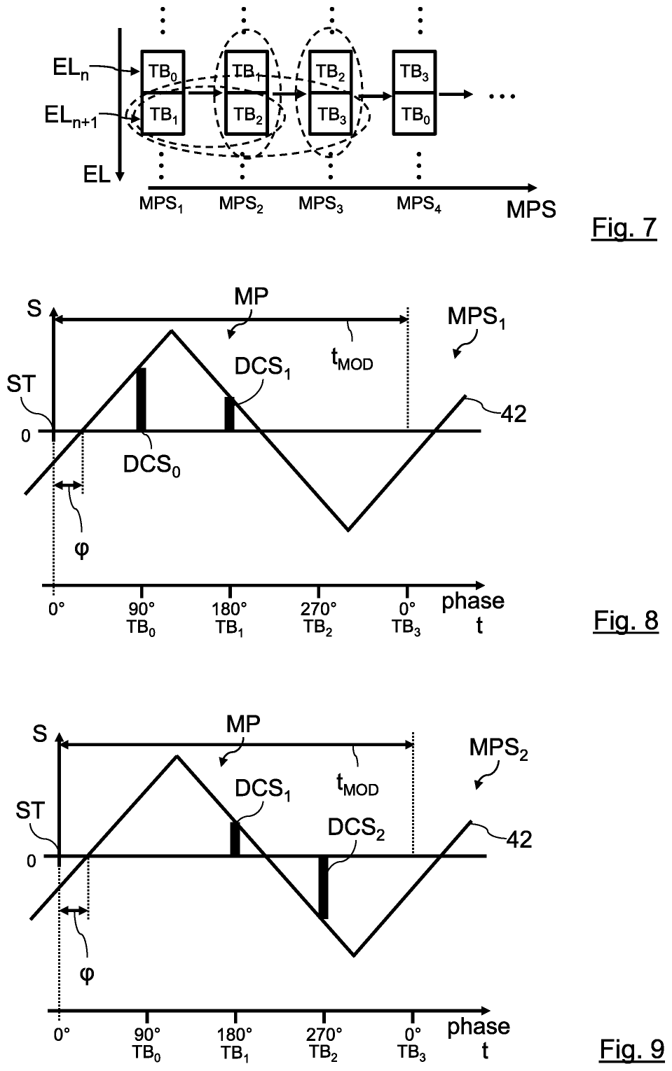

A method for operating the LiDAR system 12 to determine the phase shift (p according to a first exemplary embodiment will be explained in more detail below with reference to FIGS. 7 to 11. FIG. 7 shows a temporal control scheme according to the first exemplary embodiment for, as an example, two receiving areas ELₙ and ELₙ₊₁ for a measurement cycle containing four modulation period sequences MPS₁ to MPS₄ each having, as an example, 1000 modulation periods MP. FIGS. 8 to 11 show the specific acquired receive variables DCSᵢ compared with the reception envelope 42 in respective signal strength-time graphs. By way of example, the other receiving areas EL₁ to ELₙ₋₁ of the receiver 36 and the receiving areas above the receiving area ELₙ₊₁ are each activated in pairs according to the same control scheme. For example, multiple measurement cycles are carried out in succession using the same control scheme. For the sake of better clarity, only one measurement cycle is shown in FIG. 7 as an example.

The transmitting apparatus 22 is actuated using the control and evaluation apparatus 26 by means of the electrical transmission signals 28 to transmit the electromagnetic scanning signal 32.

The receiver pixels 38 are activated in for example four modulation period sequences MPS₁ to MPS₄ according to the control scheme from FIG. 7 as follows:

In the first modulation period sequence MPS₁, the receiver pixels 38 for example of the receiving area ELₙ are activated for detecting the echo signal 34 in the acquisition time range TB₀. The receiver pixels 38 of the adjacent receiving area ELₙ₊₁ are activated in the acquisition time range TB₁. In the first modulation period sequence MPS₁, the receiver pixels 38 of the receiving area ELₙ, as shown in FIG. 8, are used to record the receive variable DCS₀ and the receiver pixels 38 of the receiving area ELₙ₊₁ are used to record the receive variable DCS₁.

In the second modulation period sequence MPS₂, the receiver pixels 38 of the receiving area ELₙ are activated in the acquisition time range TB₁. The receiver pixels 38 of the adjacent receiving area ELₙ₋₁ are activated in the acquisition time range TB₂. In the second modulation period sequence MPS₂, the receiver pixels 38 of the receiving area ELₙ, as shown in FIG. 9, are used to record the receive variable DCS₁ and the receiver pixels 38 of the receiving area ELₙ₊₁ are used to record the receive variable DCS₂.

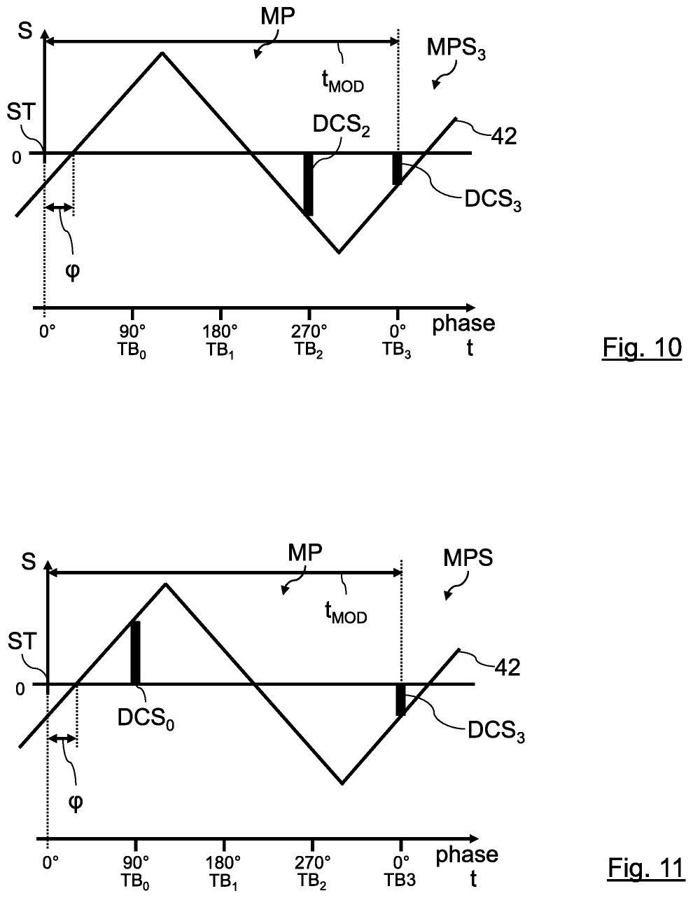

In the third modulation period sequence MPS₃, the receiver pixels 38 of the receiving area ELₙ are activated in the acquisition time range TB₂. The receiver pixels 38 of the adjacent receiving area ELₙ₊₁ are activated in the acquisition time range TB₃. In the third modulation period sequence MPS₃, the receiver pixels 38 of the receiving area ELₙ, as shown in FIG. 10, are used to record the receive variable DCS₂ and the receiver pixels 38 of the receiving area ELₙ₊₁ are used to record the receive variable DCS₃.

In the fourth modulation period sequence MPS₄, the receiver pixels 38 of the receiving area ELₙ are activated in the acquisition time range TB₃. The receiver pixels 38 of the adjacent receiving area ELₙ₊₁ are activated in the acquisition time range TB₀. In the fourth modulation period sequence MPS₄, the receiver pixels 38 of the receiving area ELₙ, as shown in FIG. 11, are used to record the receive variable DCS₃ and the receiver pixels 38 of the receiving area ELₙ₊₁ are used to record the receive variable DCS₀.

As the modulation period sequences MPSₖ progress, the counter i for the respective acquisition time range TBᵢ is increased by one both for the receiving area ELₙ and for the receiving area ELₙ₊₁. The task areas TBᵢ between the receiving area ELₙ and the receiving area ELₙ₊₁ are each offset by one here.

Altogether, the receiving areas ELₙ and ELₙ₊₁ are used to determine two support points for the reception envelope 42 for different acquisition time ranges TBₖ in each modulation period MP of each modulation period sequence MPSₖ. In successive modulation period sequences MPSₖ, altogether at least three support points are determined for three different acquisition time ranges TBₖ in each modulation period MP. In the modulation periods MP of the two modulation period sequences MPS₂ and MPS₃, even all four support points are determined for the acquisition time ranges TB₀, TB₁, TB₂ and TB₃. In a measurement cycle consisting of the modulation periods MP of the four modulation period sequences MPSₖ, the receiving area ELₙ and the receiving area ELₙ₊₁ determine all four support points for all four acquisition time ranges TBᵢ.

To determine the phase shift φ, the receive variables DCSₖ recorded in the different modulation period sequences MPSₖ for example using the receiving areas ELₙ and ELₙ₊₁ can be combined in different ways. Some possible combinations are marked with dashed ellipses in FIG. 7 by way of example.

For example, to determine the phase shift φ, the receive variables DCSₖ recorded in the same modulation period sequence MPSₖ using the receiving area ELₙ and the receiving area ELₙ₊₁ can be combined. This allows the phase shift φ to be determined from receive variables DCSₖ recorded almost simultaneously, thus achieving correspondingly lower motion blur. For example, the receive variable DCS₁ recorded in the second modulation period sequence MPS₂ using the receiving area ELₙ can be combined with the receive variable DCS₂ recorded in the second modulation period sequence MPS₂ using the receiving area ELₙ₊₁. Alternatively or additionally, the receive variable DCS₂ recorded in the third modulation period sequence MPS₃ using the receiving area ELₙ can be combined with the receive variable DCS₃ recorded in the third modulation period sequence MPS₃ using the receiving area ELₙ₊₁.

Alternatively or additionally, a receive variable DCSₐ recorded in a modulation period sequence MPSₖ using a receiving area ELₙ can be combined with a receive variable DCS_{b} recorded in a subsequent modulation period sequence MPSₖ₊₁ using the same receiving area ELₙ. For example, the receive variable DCS₁ recorded in the first modulation period sequence MPS₁ using the receiving area ELₙ₊₁ can be combined with the receive variable DCS₂ recorded in the second modulation period sequence MPS₂ using the receiving area ELₙ₊₁.

Alternatively or additionally, receive variables DCS recorded in multiple consecutive modulation period sequences MPSₖ using a receiving area ELₙ can be combined. For example, the receive variable DCS₁ recorded in the first modulation period sequence MPS₁ using the receiving area ELₙ₊₁, the receive variable DCS₂ recorded in the second modulation period sequence MPS₂ using the receiving area ELₙ₊₁, the receive variable DCS₃ recorded in the third modulation period sequence MPS₃ using the receiving area ELₙ₊₁ and the receive variable DCS₀ recorded in the fourth modulation period sequence MPS₄ using the receiving area ELₙ₊₁ can be combined to determine the phase shift φ.

In addition, the direction of the detected object 18 is determined within the receiving areas EL from the positions of the receiver pixels 38 that are used to detect the echo signal 34.

Means for specifying the acquisition time ranges TBᵢ and means for determining at least the phase shift φ can be realized by way of software and/or hardware, for example. Some or all of these means can be realized by means of the control and evaluation apparatus 26, the transmitting apparatus 22 and/or the receiving apparatus 24.

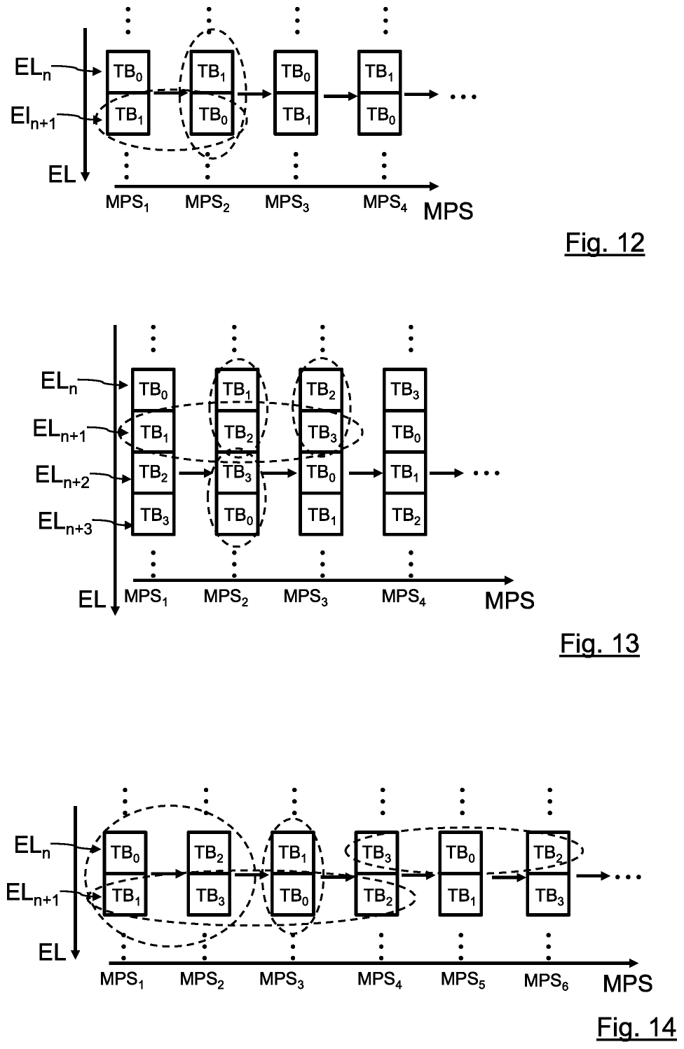

FIG. 12 shows a temporal control scheme according to a second exemplary embodiment for, as an example, two receiving areas ELₙ and ELₙ₊₁ for a measurement cycle containing four modulation period sequences MPS₁ to MPS₄. In contrast to the control scheme according to the first exemplary embodiment from FIGS. 7 to 11, the second exemplary embodiment involves the receiving areas ELₙ being activated for detecting the respective receive variables DCS₀ and DCS₁ alternately in the acquisition time range TB₀ and in the acquisition time range TB₁ in the modulation period sequences MPSₖ. In a manner offset by one from the receiving areas ELₙ, the receiving areas ELₙ₊₁ are activated for detecting the respective receive variables DCS₁ and DCS₀ alternately in the acquisition time range TB₁ and in the acquisition time range TB₀. In each modulation period MP of each modulation period sequence MPSₖ, one of the receiving areas EL is used to record the receive variable DCS₀ in the acquisition time range TB₀ and the other receiving area EL records the receive variable DCS₁ in the acquisition time range TB₁.

To determine the phase shift φ, the receive variables DCS₀ and DCS₁ recorded in the same modulation period sequence MPSₖ using the receiving areas ELₙ and ELₙ₊₁ can be combined. Alternatively or additionally, the receive variables DCS₀ and DCS₁ recorded in consecutive modulation period sequences MPSₖ and MPSₖ₊₁ using the receiving area ELₙ can be combined. Alternatively or additionally, the receive variables DCS₀ and DCS₁ recorded in consecutive modulation period sequences MPSₖ and MPSₖ₊₁ using the receiving area ELₙ₊₁ can be combined.

FIG. 13 shows a temporal control scheme according to a third exemplary embodiment for, as an example, four receiving areas ELₙ to ELₙ₊₃ for a measurement cycle containing four modulation period sequences MPS₁ to MPS₄. In contrast to the control scheme according to the first exemplary embodiment from FIGS. 7 to 11, the third exemplary embodiment involves, in addition to the receiving areas ELₙ and ELₙ₊₁, two further receiving areas ELₙ₊₃ in each modulation period MP of each modulation period sequence MPSₖ being activated in two different acquisition time ranges TB, which are also different from the acquisition time ranges TB used in the two receiving areas ELₙ and ELₙ₊₁ in the same modulation period sequence MPSₖ.

The acquisition ranges TB₂, TBs, TB₀ and TB₁ in succession are thus used in the receiving area ELₙ₊₂ in the modulation period sequences MPS₁ to MPS₄. The acquisition ranges TBs, TB₀, TB₁ and TB₂ in succession are used in the receiving area ELₙ₊₃ in the modulation period sequences MPS₁ to MPS₄.

In this way, the four receiving areas ELₙ to ELₙ₊₃ are used to determine all four specific support points for the reception envelope 42 in the four acquisition time ranges TB₀ to TBs in each modulation period MP of the modulation period sequences MPS₁ to MPS₄. The applicable receive variables DCS₀ to DCS₃ can thus be very promptly recorded within each modulation period MP of the modulation period sequences MPS₁ to MPS₄ and combined to determine the phase shift φ. This allows the distance to be determined with high resolution and relatively low motion blur.

Between successive modulation period sequences MPSₖ and MPSₖ₊₁, the respective acquisition time ranges TB are rotated in the four receiving areas ELₙ to ELₙ₊₃, so that the respective acquisition time ranges TB for each of the receiving areas ELₙ to ELₙ₊₃ also vary between the modulation period sequences MPSₖ. The receive variables DCS determined in one of the receiving areas EL in successive modulation period sequences MPSₖ and MPSₖ₊₁ can thus also be combined to determine the phase shift φ.

FIG. 14 shows a temporal control scheme according to a fourth exemplary embodiment for, as an example, two receiving areas ELₙ and ELₙ₊₁ for a measurement cycle containing four modulation period sequences MPS₁ to MPS₄ and half of a subsequent second measurement cycle containing the two modulation period sequences MPS₅ and MPS₆. The same control scheme is used for the second measurement cycle as for the first measurement cycle. The control schemes for the modulation period sequences MPS₅ and MPS₆ correspond to the control schemes for the modulation period sequences MPS₁ and MPS₂.

The acquisition ranges TB₀, TB₂, TBᵢ and TBs in succession are used in the receiving area ELₙ in the modulation period sequences MPS₁ to MPS₄. The acquisition ranges TB₁, TBs, TB₀ and TB₂ in succession are used in the receiving area ELₙ₊₁ in the modulation period sequences MPS₁ to MPS₄.

In contrast to the control scheme according to the first exemplary embodiment from FIGS. 7 to 11, the fourth exemplary embodiment involves the acquisition ranges TB₀ to TBs being varied for the two receiving areas ELₙ and ELₙ₊₁ in such a way that altogether all four acquisition ranges TB₀ to TBs are used in two specific consecutive modulation period sequences MPSₖ and MPSₖ₊₁. Therefore, the two receiving areas ELₙ and ELₙ₊₁ are used to promptly determine all four receive variables DCS₀ to DCS₃ and thus all four support points for the reception envelope 42 within two subsequent modulation period sequences MPSₖ and MPSₖ₊₁. A high resolution for the determination of the distance D with low motion blur at the same time can thus already be achieved in two modulation period sequences MPSₖ and MPSₖ₊₁ by appropriately combining the receive variables DCS₀ to DCS₃ with only two receiving areas ELₙ and ELₙ₊₁. Alternatively, a variety of other combinations of the receive variables are also available between the two subsequent modulation cycles.

1. A method for operating a detection device for determining at least distance variables that characterize distances of objects detected using the detection device,
the method comprising:
using at least one modulated electrical transmission signal to generate at least one accordingly modulated electromagnetic scanning signal,
transmitting the electromagnetic scanning signal into at least one monitoring area of the detection device,
using at least one receiving area to detect at least one signal portion of at least one electromagnetic echo signal of at least one scanning signal reflected by at least one object in at least one defined acquisition time range and to convert the signal portion into a corresponding electrical received signal,
wherein at least one defined acquisition time range is specified that is shorter than a modulation period of the at least one electrical transmission signal, and
using at least one electrical received signal to determine at least one distance variable,
wherein:
for at least one modulation period sequence, which comprises at least one modulation period of the at least one electrical transmission signal, for at least one modulation period of the at least one electrical transmission signal, using at least two receiving areas to detect respective signal portions of the at least one echo signal as electrical receive variables in different defined acquisition time ranges, and
in at least two consecutive modulation period sequences, for at least one specific modulation period of at least one electrical transmission signal, using at least two receiving areas to detect respective signal portions of the at least one echo signal as electrical receive variables in different acquisition time ranges,
wherein the interval of time between the at least two acquisition time ranges is shorter than the period duration of a modulation period of the at least one electrical transmission signal.

2. The method as claimed in claim 1, further comprising:
specifying at least one acquisition time range according to at least one defined event with regard to the at least one electrical transmission signal, and
starting at least one acquisition time range based on a start event for the at least one electrical transmission signal or for at least one modulation period of at least one electrical transmission signal.

3. The method as claimed in claim 1,
further comprising specifying at least one acquisition time range by actuating at least one receiving area with at least one acquisition control signal, or at least one periodic acquisition control signal.

4. The method as claimed in claim 1, further comprising:
using a receiving area for consecutive modulation period sequences, for at least one specific modulation period of at least one electrical transmission signal, to detect at least one specific signal portion of at least one echo signal in a respective defined acquisition time range,
using the same defined acquisition time ranges for at least one specific modulation period of the at least one transmission signal for at least two consecutive modulation period sequences,
using at least one receiving area in consecutive modulation period sequences, for at least one specific modulation period of at least one transmission signal, to detect at least one specific signal portion of at least one echo signal in a respective defined acquisition time range, and
using different defined acquisition time ranges for at least one specific modulation period of the at least one transmission signal for at least two consecutive modulation period sequences.

5. The method as claimed in claim 1,
further comprising, in at least two consecutive modulation period sequences, for at least one specific modulation period of at least one electrical transmission signal, using at least two receiving areas to detect respective signal portions of the at least one echo signal as electrical receive variables in the same acquisition time range).

6. The method as claimed in claim 1,
further comprising, in the same modulation period sequence or in a plurality of modulation period sequences, for at least one specific modulation period of at least one transmission signal, using a plurality of adjacent receiving areas to detect the respective signal portions in acquisition time ranges that are adjacent with respect to the group of acquisition time ranges that are used.

7. The method as claimed in claim 1,
further comprising, in at least one modulation period sequence or in two consecutive modulation period sequences, for at least one specific modulation period of at least one transmission signal, using multiple receiving areas to detect respective signal portions of at least one echo signal altogether in all acquisition time ranges of a group of acquisition time ranges that are used for the method.

8. The method as claimed in claim 1,
further comprising using signal sections of at least one echo signal that are detected using multiple receiving areas for at least one specific modulation period of at least one transmission signal in the same modulation period sequence to determine at least one distance variable, or
using signal sections of at least one echo signal that are detected using at least one receiving area for at least one specific modulation period of at least one transmission signal in at least two successive modulation period sequences to determine at least one distance variable.

9. The method as claimed in claim 1, wherein at least one acquisition time range is referenced to at least one characteristic point in at least one electrical transmission signal and at least one scanning signal.

10. The method as claimed in claim 1,
wherein intervals of time between at least two acquisition time ranges of a group of acquisition time ranges that are used are specified according to the intervals of time between characteristic points in at least one electrical transmission signal and at least one scanning signal.

11. The method as claimed in claim 1, wherein at least one electrical transmission signal is produced as a square-wave signal, a sinusoidal signal, a triangular-waveform signal or a sawtooth signal.

12. The method as claimed in claim 1, further comprising:
using at least two receiving areas, which are spatially adjacent, to detect at least one specific signal portion of at least one echo signal in respective defined acquisition time ranges,
wherein the interval of time between the defined acquisition time ranges is shorter than the period duration of a modulation period of at least one transmission signal,
directing at least one echo signal to the receiving areas in such a way that at least two receiving areas that are used to detect a specific signal portion of the at least one echo signal in respective defined acquisition time ranges are hit by the at least one echo signal at the same time, and
forming at least one receiving area from at least two receiving elements that are arranged in such a way that they are hit by respective components of the at least one echo signal that are transmitted to the at least one receiving area according to a direction of a reflecting object relative to the detection device,
wherein the at least two receiving elements are used to detect the respective components of the at least one echo signal separately.

13. A detection device for determining at least distance variables that characterize distances of objects detected using the detection device,
wherein the detection device comprises:
at least one transmitting apparatus that allows at least one modulated electrical transmission signal to be used to generate at least one electromagnetic scanning signal that can be transmitted into at least one monitoring area of the detection device,
at least one receiving apparatus comprising at least one receiving area that can be used to detect at least one signal portion of at least one electromagnetic echo signal of at least one scanning signal reflected by at least one object in at least one defined acquisition time range and to convert said signal portion into a corresponding electrical received signal,
at least one means that can be used to specify at least one defined acquisition time range that is shorter than a modulation period of the at least one electrical transmission signal, and
at least one means that allows at least one electrical received signal to be used to determine at least one distance variable,
wherein the detection device further comprises:
at least two receiving areas that can be used to detect respective signal portions of the at least one echo signal as electrical receive variables in different defined acquisition time ranges, and
means for producing at least two acquisition time ranges,
wherein the interval of time between the acquisition time ranges is shorter than the period duration of a modulation period of the at least one transmission signal.

14. The detection device as claimed in claim 13,
wherein at least one receiving area comprises multiple receiving elements.

15. A vehicle comprising at least one detection device for determining at least distance variables that characterize distances of objects detected using the detection device,
wherein the vehicle comprises:
at least one transmitting apparatus that allows at least one modulated electrical transmission signal to be used to generate at least one electromagnetic scanning signal that can be transmitted into at least one monitoring area of the detection device,
at least one receiving apparatus comprising at least one receiving area that can be used to detect at least one signal portion of at least one electromagnetic echo signal of at least one scanning signal reflected by at least one object in at least one defined acquisition time range and to convert said signal portion into a corresponding electrical received signal,
at least one means that can be used to specify at least one defined acquisition time range that is shorter than a modulation period of the at least one electrical transmission signal, and
at least one means that allows at least one electrical received signal to be used to determine at least one distance variable,
wherein the detection device comprises at least two receiving areas that can be used to detect respective signal portions of the at least one echo signal as electrical receive variables in different defined acquisition time ranges, and the detection device comprises means for producing at least two acquisition time ranges, the interval of time between which is shorter than the period duration of a modulation period of the at least one transmission signal.
